(19) United States
(12) Patent Application Publication
(10) Pub. No.: US 2014/0238332 A1
(43) Pub. Date: Aug. 28, 2014

(54) METHOD FOR PRODUCING A COOLING-DUCT PISTON AND ASSOCIATED PISTON

(71) Applicants: Matthias Laqua, Bad Wimpfen (DE); Volker Lehnert, Obereisesheim (DE)

(72) Inventors: Matthias Laqua, Bad Wimpfen (DE); Volker Lehnert, Obereisesheim (DE)

(73) Assignee: KS KOLBENSCHMIDT GMBH, Neckarsulm (DE)

(21) Appl. No.: 14/115,161

(22) PCT Filed: May 3, 2012
(86) PCT No.: PCT/EP2012/058082

§ 371 Date: May 16, 2014

(30) Foreign Application Priority Data
May 4, 2011 (DE) 102011100470.3

(51) Int. Cl. F02F 3/22

(52) U.S. Cl. CPC F02F 3/22
USPC 123/193.6; 29/888.07

(57) ABSTRACT

A method for producing a cooling-duct piston for an internal combustion engine, composed of a piston upper part and a piston lower part, wherein the piston upper part is detachably connected to a piston lower part and a cooling duct is formed in the region between the piston upper part and the piston lower part which is charged with coolant via at least one inlet opening during the operation of the cooling duct piston and out of which coolant flows again via at least one outlet opening. In a first step, the piston upper part is detached and separated from the piston lower part, and subsequently a ring, which has at least on discharge opening, is fastened to the inlet opening and finally the piston upper part and the piston lower part reconnected. The cooling duct can be charged with coolant via the inlet opening. A cooling duct piston for an internal combustion engine is also disclosed.

### BACKGROUND

The disclosure relates to cooling duct pistons and methods for producing a cooling duct piston for an internal combustion engine.

An oil-cooled reciprocating piston for an internal combustion engine, consisting of a piston upper part and a piston lower part connected to the upper part by means of clamp screws is known from DE 35 11 853 C1. The piston upper part is supported on the underside of an annular projecting ring formed on the inside of the piston crown on a contact surface on the piston lower part. Furthermore, an inner piston cooling space is present, bounded by the annular projection, the piston crown and the upper side of the piston lower part, which space is connected via passages piercing the projecting ring to an outer piston cooling space externally surrounding the annular projection, bounded at the top by the piston crown, on the outside by the outer wall of the piston upper part and at the bottom by the top side of the piston lower part. Cooling oil for shaker cooling can be introduced into one of the two piston cooling spaces via at least one feed opening, transferrable from the space via the passages into the other piston cooling space and removable from the space via at least one exit hole. In addition, at least the outer piston cooling space has drilled blind holes as an expansion.

The disadvantage of pistons with a cooling duct known from the prior art is that they are cooled only by means of the shaker effect. Furthermore, oil carbon builds up on the surface of the cooling duct when the cooling duct piston is operating in an internal combustion engine. In addition, the piston cannot be cooled with coolant in specific areas, particularly areas subjected to high temperatures.

It would be desirable therefore, to create a piston that avoids the disadvantages noted above and that can be produced simply and cost-effectively.

### SUMMARY

These features can be achieved by detaching the piston upper part from the piston lower part in a first process step so that the piston upper part is separate from the piston lower part, and then a ring having at least one spray opening, such as at least one nozzle-shaped opening, is attached to the inlet opening, and finally the piston upper part and the piston lower part are connected again, wherein the cooling duct can continue to be charged with coolant via the inlet opening.

A piston produced in this way can be cooled selectively and continuously at specific positions through the orientation of the spray opening. Furthermore, the operating life and operational safety of the cooling duct piston is improved when operating in an internal combustion engine because the coolant is firstly is sprayed out of the at least one spray opening due to the shaker effect and, in addition, is sprayed under pressure continuously from the at least one spray opening independently of the shaker effect. Furthermore, by selective orientation of the spray openings, oil carbon buildup on the inside of the cooling duct can be prevented and, if necessary, reduced by being washed down with the sprayed coolant stream as a form of cleaning. In addition, a piston that has already been produced can be made simply and cost-effectively by retroactive assembly by retrofitting one such piston with the ring. No design change to the piston is necessary with retroactive assembly. Using the ring in the form of a retroactively installed oil distribution ring, a retrofit kit (modernization package) can be assembled for the retroactive production of a piston with optimized cooling using an oil distribution ring.

The piston upper part and the piston lower part can be connected using at least one threaded connection, such as by using at least one stud and at least one nut. This makes it possible for the piston upper part to be separable from the piston lower part. The piston upper part can be produced separately from the piston lower part. Alternatively, the piston upper part can be produced along with the piston lower part.

After the separation and prior to the joining, at least one bushing can be employed in the area between the ring to be attached and the piston lower part. This makes it possible for the spray opening to have sufficient clearance to the inside of the cooling duct. In particular, by using the bushing, sufficient clearance can be ensured between the piston crown inner side that is located in the cooling duct opposite the outer side of the piston upper part on the inside of the piston, and the spray opening.

The ring can be attached to the inlet opening in such a way that a thread is cut into the inlet opening and then the ring is attached to the inlet opening using a fastening screw, such as by using a hollow bolt. Prior to the disassembly of piston upper part and piston lower part, coolant, for example cooling oil, flowed through the inlet opening into the cooling duct in the form of a charge when the cooling duct piston was in operation. Following the disassembly of piston upper part and piston lower part, a suitable thread is cut into the inlet opening, wherein the attaching screw can be screwed solidly into the inlet opening. Where there are several passages in the cooling duct, a thread is preferably cut in all the respective inlet openings. Alternatively, a thread is cut in only some of the inlet openings. In those inlet openings having a thread, a single attaching screw is used. Before the attaching screw is tightened to the inlet opening, the ring is inserted between the inlet opening and the attaching screw. The ring has a shape by which the ring can be positioned suitably at one area of the cooling duct surface during the tightening and after the tightening of the attaching screw. A hollow bolt is used as the attaching screw, which, in addition to its function as an assembly screw, allows the coolant to pass through so that coolant continues to flow through the inlet opening when the piston is operating in an internal combustion engine.

After the ring has been installed in the cooling duct, the cooling duct is divided into two areas. The two areas are connected to each other by a gap between the cooling duct and the ring. A pressure chamber, from which coolant can spray via at least one spray opening, is formed between the ring upper part and the ring lower part to spray coolant into an area of the cooling duct.

Alternatively, by means of the geometric design of the ring there may be no gap present between the cooling duct and the ring so that the two areas are not directly connected. This makes it possible for a pressure chamber to be formed between the ring and one area of the cooling duct by taking coolant under pressure through the inlet opening into the one area formed between the cooling duct and the ring. Then coolant sprays under pressure into the other area from the autonomously formed pressure chamber as the coolant is sprayed from at least one spray opening in the ring in the towards the inner wall of the cooling duct, preferably the cooling duct on the piston upper side.

In one aspect, a sleeve is inserted between the ring to be fastened and the inlet opening before the ring is attached using the fastening screw. Then the fastening screw is bolted tightly to the inlet opening, wherein the fastening screw is inserted through the ring and the sleeve before it is tightened.

The ring can consist of two parts, that is to say, a ring upper part and a ring lower part, wherein the ring lower part is connected to the inlet opening and the ring upper part is connected to the ring lower part. The ring upper part has at least one spray opening. Using the ring upper part and the ring lower part, it is possible to position the ring in the cooling duct with particular ease. The ring upper part and the ring lower part can be formed as a single piece. Alternatively, the ring upper part and the ring lower part can be assembled from several individual pieces into one component.

The ring lower part can be connected to the inlet opening in such a way that a thread is cut into the inlet opening and then the ring lower part is attached to the inlet opening with a fastening screw, preferably using a hollow bolt, and in such a way that the ring upper part is attached to the ring lower part such that the ring upper part is bolted to the ring lower part by means of at least one fastening screw, such as by means of at least one countersunk screw.

The cooling duct piston for an internal combustion engine is produced in accordance with the method.

In one aspect, the ring consists of steel, aluminum, an aluminum alloy and/or a hard rubber. In this way, it is possible that the ring does not substantially change the weight of the cooling duct piston and it can also be produced easily and cost-effectively. Furthermore, using hard rubber allows the ring to conform optimally to the contour of the cooling duct.

In one aspect of the cooling duct piston, the ring has at least one spray opening, such as at least one nozzle-shaped opening. The nozzle-shaped opening can be configured, for example, as a spray nozzle, or in the shape of a venturi nozzle. Alternatively, it is possible that the spray opening is configured as a simple drilled hole.

In another aspect, the ring consists of two parts, wherein coolant is sprayed under pressure from the at least one spray opening of the ring upper part. A pressure chamber is formed between the ring lower part and the ring upper part, as pressure is built up continuously. This pressure is generated by means of the coolant flowing in through the inlet opening, wherein the coolant is pumped into the pressure chamber under pressure. Then the coolant leaves from the one spray opening of the ring at a specific pressure and volumetric flow and strikes in an area of the inner side of the cooling duct oriented by the alignment of the spray opening.

When the piston is operating in the internal combustion engine, a coolant stream under pressure is generated that flows from the particular spray opening. The flowing coolant stream is amplified by the shaker movement of the coolant generated by the reciprocal motion of the piston, wherein particularly with a movement towards the connecting rod, that is to say with a downward movement of the piston in the internal combustion engine, the strength of the coolant stream is amplified. With a shaker effect, the coolant in the piston is moved because of the movement of the piston by the mass inertia of the coolant. Additionally, coolant sprayed from the ring in the cooling duct itself is moved because of the shaker effect. Particularly, the coolant leaves the discharge opening of the ring continuously and independently of the motion of the cooling duct piston in the internal combustion engine.

The cooling duct in the area between the piston upper part and the piston lower part can be round, elliptical, rectangular, square and/or similar. The cooling duct can be completely peripheral around the reciprocating axis of the piston. Alternatively, the cooling duct can be interrupted in its periphery around the reciprocating axis of the piston, wherein, in the case of an intermittent cooling duct, at least one non- circumferential ring section is preferably used for the particular cooling duct areas that are interrupted.

### BRIEF DESCRIPTION OF THE DRAWING

The description herein makes reference to the accompanying drawings wherein like reference numerals refer to like parts throughout the several views, and wherein:

FIG. 1 is a longitudinal cross-sectional view of a cooling duct piston without a retrofitted ring;

FIG. 2 shows a cooling duct piston with a ring in a side cross-sectoned elevation;

FIG. 3 shows a cooling duct piston with a ring in a different side cross-sectioned elevation;

FIG. 4 shows a plan view of the piston lower part of the cooling duct piston;

FIG. 5 is a side elevational view of a fastening screw;

FIG. 6 is a plan view of a lower part of the ring;

FIG. 7 is a plan view of an upper part of the ring

FIG. 8 is a cross-section of a portion of the ring upper part;

FIG. 9 is a cross-section of another portion of the ring upper part;

FIG. 10 is a sleeve in a side elevation;

FIG. 11 is a plan view of the sleeve;

FIG. 12 is a cross-section of a portion of the piston lower part;

FIG. 13 is a cross-section at one position of a portion of the piston lower part; and

FIG. 14 is a cross-section at a different position of the ring lower part.

### DETAILED DESCRIPTION

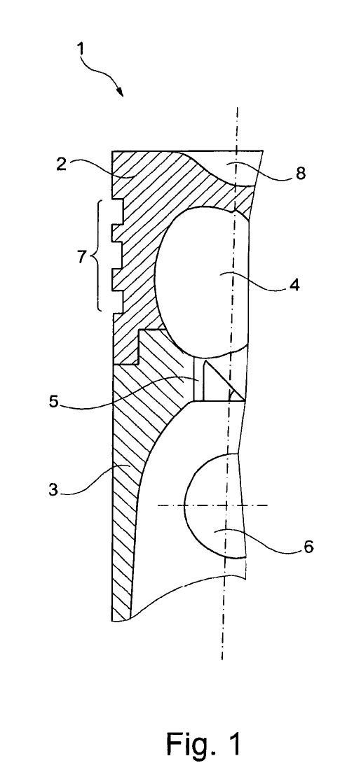

A simplified section of a cooling duct piston 1 for an internal combustion engine is shown in cross-section in FIG. 1. The cooling duct piston 1 consists of a piston upper part 2 and a piston lower part 3. In the case of the cooling duct piston shown in FIG. 1, the piston upper part 2 is detachably connected to the piston lower part 3, by having the piston upper part 2 and the piston lower part 3 connected by at least one stud 16 (not shown in FIG. 1) and by at least one nut 17 (not shown in FIG. 1). In this aspect, the piston upper part 2 and the piston lower part 3 are connected by four studs 16 and four nuts 17 that are arranged symmetrically to each other in the cooling duct piston 1. The spacing of the directly adjacent nuts 17 and the studs 16 is equal in each case.

As shown in FIG. 1, a cooling duct 4 is formed in the area between the piston upper part 2 and the piston lower part 3. The cooling duct 4 is completely circumferential radially around the center axis of the cooling duct piston 1. In this aspect, the center axis of the cooling duct piston 1 corresponds to the reciprocating axis of the cooling duct piston 1 that the cooling duct piston 1 passes through when it is operating in an internal combustion engine.

The piston lower part 3 furthermore has at least one inlet opening 5 and a piston pin 6 bore passing through the piston lower part 3. In this aspect, the piston lower part 3 has four inlet openings 5 for charging the coolant, one of which is shown as an example in FIG. 1.

The piston upper part 2, in accordance with FIG. 1, has in addition a ring belt 7 with grooves for piston rings (not shown) and a combustion chamber bowl 8.

The cooling duct 4 is charged with coolant through the inlet openings 5 when the cooling duct piston 1 is operating in an internal combustion engine. To achieve this, the coolant is conducted via the piston pin bore 6 into the pertinent inlet opening 5 to cool the cooling duct piston 1.

The coolant that has flowed in and been heated in the cooling duct 4 flows out of the cooling duct 4 through at least one outlet opening 14 (not shown in FIG. 1).

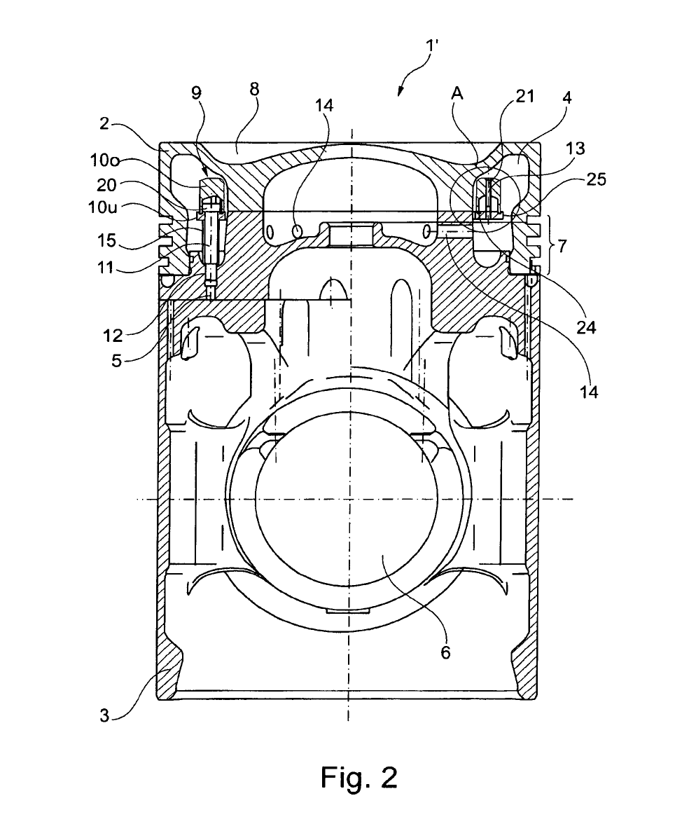

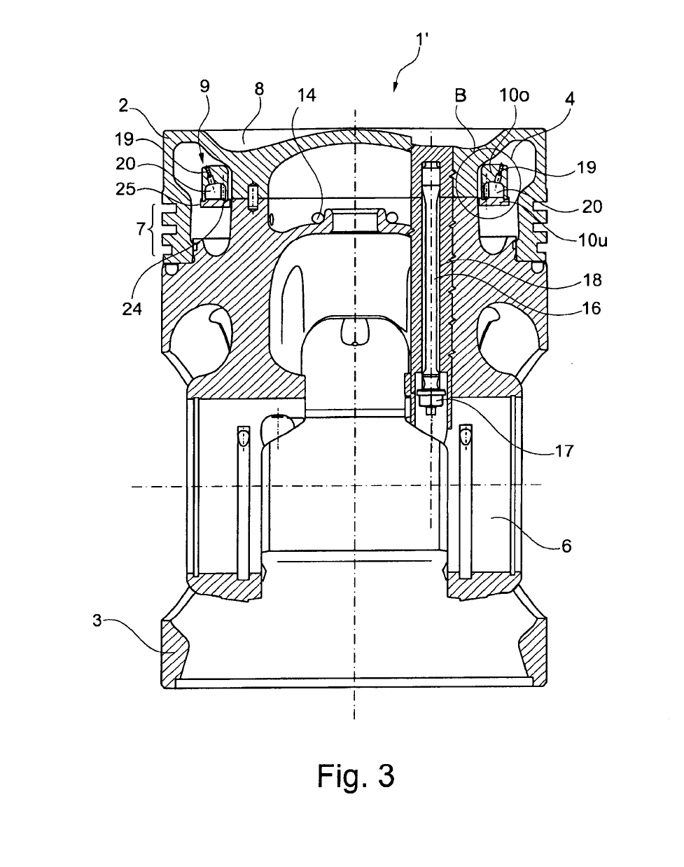

FIGS. 2 and 3 show a cooling duct piston 1′ for an internal combustion engine with a retrofitted ring 9, compared with the cooling duct piston 1.

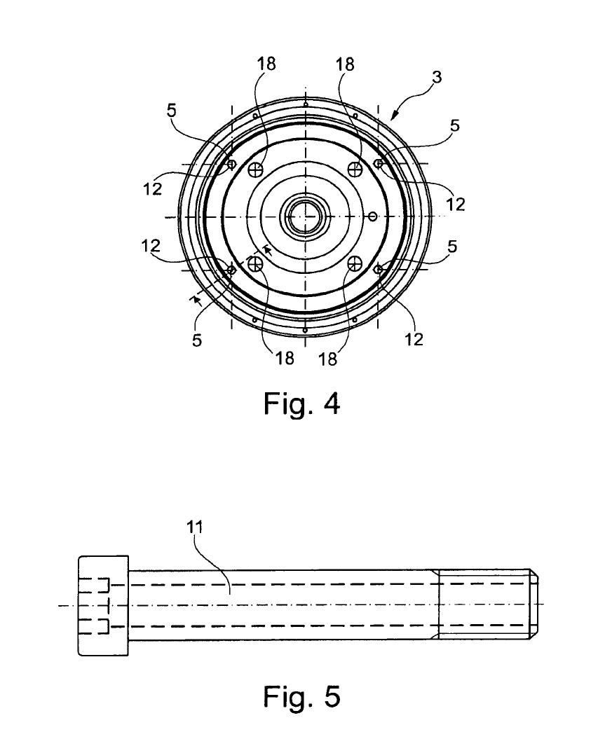

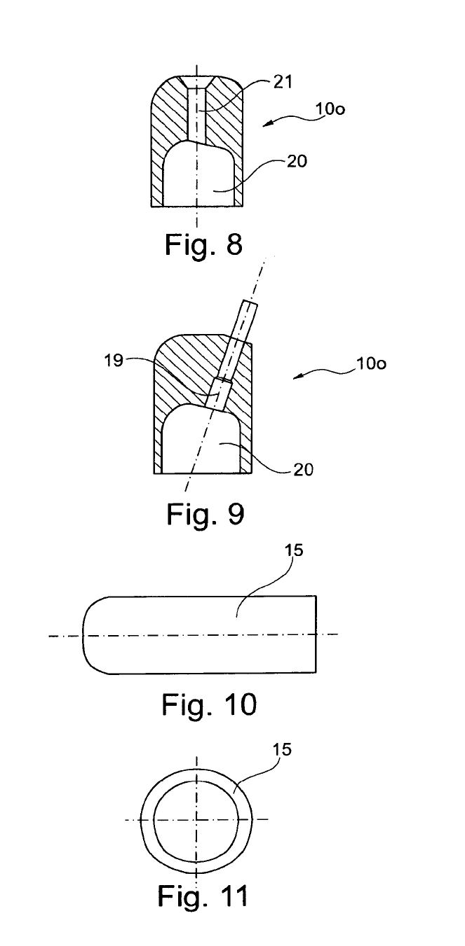

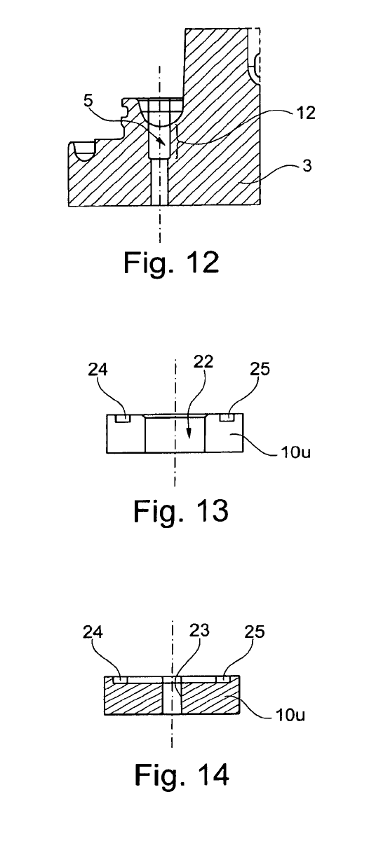

FIG. 2 shows the completed cooling duct piston 1′ looking towards the piston pin bore 6 and in FIG. 3 perpendicular to the piston pin bore 6 shown in cross-section in a side elevation. FIG. 4 shows the plan view of the piston lower part 3 for the cooling duct piston 1′, not yet connected to the piston upper part 2. FIGS. 5 to 7 and FIG. 10 and FIG. 11 respectively show components of the retrofitted cooling duct piston 1′. FIG. 8 and FIG. 9 each show a section of the ring upper part 10o in cross-section at different positions. FIG. 12 shows a section of the cooling duct piston 1′ in cross-section in the area of an inlet opening 5. FIGS. 13 and 14 each show a section of a ring lower part 10u in cross-section at different positions. Identical components are given the same reference numerals in FIGS. 2 to 14, and new components are given new reference numerals in FIGS. 2 to 14.

The cooling duct piston 1′ shown in FIGS. 2 and 3 was produced using the above-described method so that the cooling duct piston 1′ differs in some features from the cooling duct piston 1 from FIG. 1. Some of the common features and the different features are shown in detail in the following:

One of the four studs 16 to connect the piston upper part 2 to the piston lower part 3 is shown in FIG. 3, to which a nut 17 is tightened on the finished piston 1′. The symmetrical spacing of the four holes 18 for the four studs 16 for the cooling duct piston 1′ is shown in FIG. 4. Further, an exit opening 14 for the coolant is shown in cross-section as an example in FIG. 2. The cooling duct piston 1′ does not differ in these features from the cooling duct piston 1 shown in FIG. 1. In comparison with the cooling duct piston 1, the cooling duct piston 1′ has a ring lower part 10u located in the cooling duct and a ring upper part 10o separate therefrom in accordance with FIG. 2 and FIG. 3. The ring lower part 10u and the ring upper part 10o in the aspect are made of aluminum. When assembled, the ring lower part 10u and the ring upper part 10o form the ring 9. In the aspect, the ring lower part 10u and the ring upper part 10o are configured as separate parts in accordance with FIGS. 10 and 11. Since the cooling duct 4 is configured radially circumferential around the center axis of the cooling duct piston 1′, the ring upper part 10o and the ring lower part 10u in the aspect are also radially circumferential, matched to the contour of the cooling duct.

The ring lower part 10u is rigidly connected to the piston lower part 3 with the aid of four hollow bolts 11 by screwing the four hollow bolts 11 into an corresponding inlet opening 5. The four inlet openings 5 have a suitable thread 12 for a hollow bolt 11. In the aspect, the inlet openings 5 have an M14 thread. An inlet opening 5 in the piston lower part 3 with an M14 thread is shown as an example in FIG. 12.

A hollow bolt 11 is shown as an example in FIG. 2 following its assembly in the cooling duct piston 1′. FIG. 5 shows an example of a hollow bolt 11 as an individual component.

The ring upper part 10o is connected in this aspect to the ring lower part 10u by means of eight countersunk bolts 13. In this aspect, the ring lower part 9 has eight matching threaded holes 23 for the countersunk bolts 13 and the ring upper part 10o has eight holes 21 for the countersunk bolts 13 through which a respective bolt 13 is pushed. M5×50 size bolts 13 are used in this aspect.

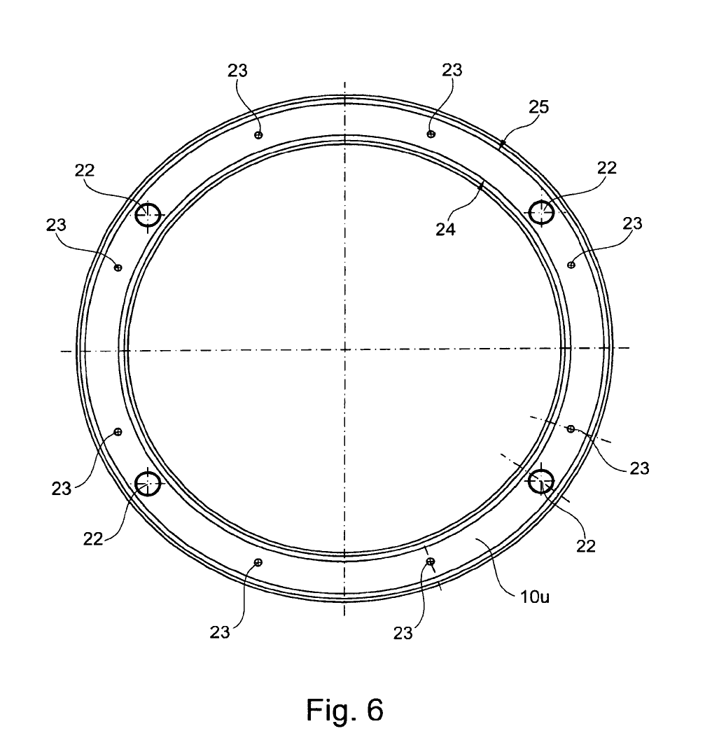

FIG. 6 shows in detail the eight threaded holes 23, one for each countersunk bolt 13, and the disposition of the threaded holes 23 in the ring lower part 10u. FIG. 6 moreover shows in detail four holes 22, each for one hollow bolt 11. As an example, a hole 22 is shown in FIG. 13 in which a ring lower part 10u is shown as a cross-section.

In the cooling duct piston 1′ as produced in accordance with FIGS. 2 and 3, a hollow bolt 11 is passed through the holes 22. As an example, a threaded hole 23 with an M5 thread is shown in the ring lower part 10u cross-section.

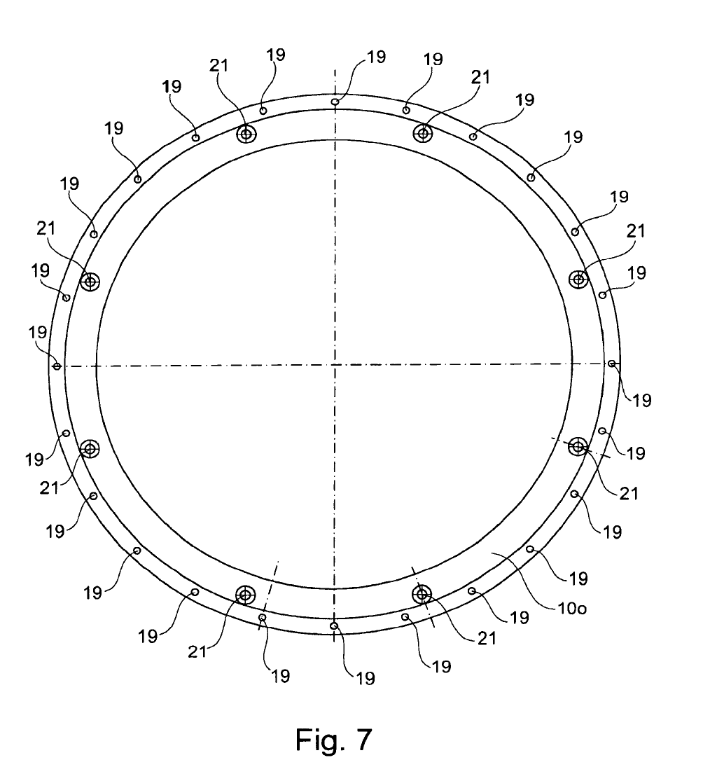

The eight holes 21 for the countersunk screws 13 and their disposition in the ring upper part are shown in detail in FIG. 7.

In accordance with FIG. 6, the threaded holes 23 and the holes 22 are distributed symmetrically in the ring lower part 10u. In addition, the holes 21 are arranged symmetrically in the ring upper part 10u as shown in FIG. 7.

In the aspect in accordance with FIG. 2, a countersunk screw 13 is shown as an example, solidly connected to the ring lower part 10u by means of a threaded hole 23 to the ring lower part 10u and is pressed through the hole 21 of the ring upper part 10o.

In accordance with FIG. 7, the ring upper part 10o in this aspect has in addition 24 spray openings 19 that are arranged symmetrically according to FIG. 7. The spacing of the adjacent spray openings 19 from each other is equidistant in accordance with FIG. 7.

FIG. 8 shows a section of the ring upper part 10o in cross-section. This view matches the section A in FIG. 2. One of the eight holes 21 for the specific countersunk screw 13 is shown in detail in FIG. 8. In addition, FIG. 8 shows in detail a pressure chamber 20 of the ring upper part 10o in the shape of a recess. In this aspect, the pressure chamber 20 is completely circumferential radially about the center axis of the cooling duct piston 1′ in the piston upper part 100.

FIG. 9 shows a cross-section of a section of the ring upper part 100. The view of the ring upper part 10o from FIG. 9 matches the section B of the ring upper part 10o from FIG. 3. The spray openings 19 in accordance with FIG. 9 all have a nozzle-shaped opening in the shape of a spray nozzle. FIG. 9 additionally shows the peripheral pressure chamber 20 of the upper ring part 100.

A bushing 15 is located between the ring lower part 10u and the four inlet openings 5, each of which is set into an inlet opening 5. A hollow bolt 11 is inserted through the bushing 15. This ensures a specific distance from the ring upper part 10o to the top side of the cooling duct 4. In FIG. 2 a bushing 15 inserted into the inlet opening 5 is shown as an example in the area between the attached ring 9 and the piston lower part 3 after the cooling duct piston 1′ has been produced.

FIGS. 10 and 11 each show the bushing as a single component, where, in accordance with FIG. 10, the bushing 15 is shown in a side elevation and in accordance with FIG. 11 the bushing is shown towards its center axis, that is to say, in a plan view. FIG. 2 shows an example of an assembled bushing 15 in the cooling duct piston 1′.

The method for producing the cooling duct piston 1′ shown in FIGS. 2 and 3 is described in detail in the following.

The piston upper part 2 is detached in a first process step from the piston lower part 3 in the cooling duct piston 1 shown in FIG. 1. To do this, the four nuts 17 are loosened, wherein each nut 17 is connected to a stud 16 before the nuts 17 are loosened. Then the four studs 16 in the piston upper part are detached.

As a result, the piston upper part 2 is easily separable from the piston lower part 3 so that, after the piston upper part 2 and the piston lower part 3 are separated, there are two separate components, namely, the piston upper part 2 and the piston lower part 3.

Then it is possible to retrofit the ring 9 consisting of the ring upper part 10o and the ring lower part 10u to improve the cooling of the cooling duct piston 1 and to clean the wall of the cooling duct 4 of oil soot in the cooling duct 4 of the cooling duct piston 1. The ring 9, consisting of two parts, is available as a retrofit kit along with at least suitable bushings 15 and attaching screws in the form of countersunk screws 13 and hollow bolts 11 as a package for installation in the cooling duct piston 1.

In order to retrofit the ring 9, a thread 12 is cut into each of the four inlet openings 5 of the piston lower part. In this aspect, a thread 12 size M14 is cut into the respective inlet opening 5. Then the four threads are cleaned. The cut threads 12 are shown in FIG. 4.

After the piston upper part 2 and the piston lower part 3 have been separated, and before fastening the ring 9 to be attached in the form of the ring lower part 10u to the respective inlet opening 5, one of the four bushings 15 is inserted into one of the four inlet openings 5.

Then the ring lower part 10u is attached to the four inlet openings 5, attaching the ring lower part 10u to the four inlet openings 5 of the piston lower part 3 using the four hollow bolts 11. In each case, a hollow bolt 11 is inserted through one of the bushings 15 before being attached to the respective inlet opening 5. The ring lower part 10u to be attached is shown in FIG. 6.

For the attaching, one hollow bolt 11 is screwed in each case into one inlet opening 5. The hollow bolt 11 to be attached in each case is inserted through a bushing 15. In this aspect, an adhesive is applied in addition to the threads 12 of the inlet openings 5 before the bolts 11 are tightened; after it has cured, it provides an unbreakable connection between the respective hollow bolt 11 and the inlet opening 5.

After the ring lower part 10u has been joined to the four inlet openings 5, the ring upper part 10o is attached to the ring lower part 10u.

To do this in this aspect, the ring upper part 10o is set on the ring lower part 10u. In FIGS. 2, 3, 6, 13 and 14, grooves 24, 25 are shown in the ring lower part 10u into which the ring upper part 10o can be inserted simply, to fit in accordance with FIG. 2 and FIG. 3.

Subsequently, the ring upper part 10o is bolted to the ring lower part 10u by screwing one of the eight countersunk screws 13 into one of the respective eight holes 21. As shown in FIGS. 2 and 3, the pressure chamber is formed between ring upper part 10o and ring lower part 10u.

Then the piston upper part 2 and the piston lower part 3 are connected again.

To do this, the four studs 16 are screwed into the piston upper part 2 again. Then the piston upper part 2 and the piston lower part 3 are attached again using the nuts 17 and the studs 16 by tightening one of the four nuts 17 onto a respective stud 16.

A cooling duct piston 1′ produced and completed using the method is shown in FIGS. 2 and 3.

As an example, the cooling of the cooling duct piston 1′ will be shown in accordance with FIGS. 2 and 3.

When operating the cooling duct piston 1′ shown in FIGS. 2 and 3 in an internal combustion engine, coolant, for example, cooling oil, is pumped continuously from the piston pin bore 6 into the four inlet opening 5. The inlet openings 5 thus also have the function, in addition to securing the ring 9, of charging the coolant duct 4 with coolant.

The coolant brought under pressure to the four inlet openings 5 is then pumped further through the specific hollow bolt 11 of the inlet openings 5 into the pressure chamber 20 so that pressure is constantly built up in the pressure chamber 20. During operation, the pressure chamber 20 is filled completely with coolant under pressure. The pressure chamber 20 is located, in accordance with FIG. 2 inside the cooling duct 4, wherein the pressure chamber 20 itself is formed between the ring upper part 10o and the ring lower part 10u.

As a result of the coolant under pressure in the pressure chamber, coolant is sprayed continuously out of the 24 spray openings 19 into the cooling duct independently of the motion of the cooling duct piston 1′ in the internal combustion engine. The coolant exits continuously at a specific pressure and volume from the respective spray openings 19, wherein the shaker effect in this aspect does not have any negative effect on spraying the coolant from the pressure chamber 20 towards the surface of the cooling duct 4.

In this aspect, the diameter of the spray openings 19 and the number of spray openings 19 are matched to each other in such a way that optimal cooling of the cooling duct piston 1′ is ensured. As a result, selective cooling of the inside of the cooling duct 4 is possible, whereby the piston upper part 2 in particular and the area below the combustion chamber bowl 8 can be cooled especially optimally. Furthermore, as a result of the emerging stream of coolant from the particular spray opening 19, the buildup of oil carbon on the upper side of the cooling duct 4, that is to say on the opposite side from the combustion chamber bowl 8, can be removed and is thus reducible. Furthermore, as a consequence of the stream of coolant spray from the particular spray opening 19, new buildup of oil carbon on the inside of the cooling duct is prevented when the cooling duct piston 1′ is operating in an internal combustion engine.

The coolant sprayed from the spray openings 19 and heated in the cooling duct then flows out of the cooling duct 4 again through the exit openings 14.

1. A method for producing a cooling duct piston for an internal combustion engine, consisting of a piston upper part and a piston lower part, wherein the piston upper part is detachably connected to the piston lower part and a cooling duct is formed in the area between the piston upper part and the piston lower part that is charged with coolant through at least one inlet opening during operation of the cooling duct piston from which coolant flows out again via at least one outlet opening, comprising:
detaching the piston upper part is detached from the piston lower part so that the piston upper part is separated from the piston lower part;
attaching at least one ring having at least one spray opening to the inlet opening; and
then reconnecting the piston upper part and the piston lower part to each other, wherein the cooling duct can continue to be charged with coolant via the inlet opening.

2. The method from claim 1, comprising:
connecting the piston upper part and the piston lower part using at least one threaded connection, including at least one stud and at least one nut.

3. The method from claim 1 comprising:
at least one bushing in the area between the ring and the piston lower part when they are separated and before they are joined.

4. The method from claim 1, comprising:
attaching the ring with the inlet opening is attached in such a way that a thread is cut into the inlet opening and the ring is subsequently attached to the inlet opening using a hollow bolt.

5. The method from claim 1, comprising:
forming the ring consists of two parts including a ring lower part and a ring upper part; and
fastening the ring lower part to the inlet opening, and fastening the ring upper part is fastened to the ring lower part.

6. The method from claim 5, comprising:
fastening the ring lower part is fastened to the inlet opening such a way that a thread is cut into the inlet opening and the ring lower part is subsequently connected to the inlet opening using a hollow bolt;
attaching the ring upper part to the ring lower part by bolting the ring upper part to the ring lower part using at least one attaching screw.

7. A cooling duct piston for an internal combustion engine having a piston upper part and a piston lower part, wherein comprising:
the piston upper part and the piston lower part are detachably connected and a cooling duct is formed in the area between the piston upper part and the piston lower part, wherein the cooling duct has at least one inlet opening for charging the coolant and at least one outlet opening for coolant to flow out,
characterized in that the cooling duct piston produced in accordance with the steps of claim 1.

8. The cooling duct piston from claim 7, wherein:
the ring is formed of one of steel, aluminum, an aluminum alloy and a hard rubber.

9. The cooling duct piston from claim 7, wherein:
the ring has at least one spray opening.

10. A cooling duct piston for an internal combustion engine comprising:
a piston upper part and a piston lower part;
the piston upper part and the piston lower part being connected;
a cooling duct formed in the area between the piston upper part and the piston lower part;
the cooling duct having at least one inlet opening for charging coolant into the cooling duct and at least one outlet opening for coolant to flow out; and
at least one ring having at least one spray opening attached to the inlet opening.

11. The cooling duct piston from claim 7, wherein:
the ring is formed of one of steel, aluminum, an aluminum alloy and a hard rubber.

12. The cooling duct piston from claim 7, wherein:
the ring has at least one spray opening.

13. The cooling duct piston from claim 10, wherein:
the piston upper part and the piston lower part are connected using at least one threaded connection including at least one stud and at least one nut.

14. The cooling duct piston from claim 10 further comprising:
at least one bushing inserted in the area between the ring and the piston lower part.

15. The cooling duct piston method from claim 10, wherein:
a thread is cut into the inlet opening; and
the ring is attached to the inlet opening using a hollow bolt.
